(19) United States
(12) Patent Application Publication
(10) Pub. No.: US 2014/0281613 A1
(43) Pub. Date: Sep. 18, 2014

(54) FREQUENCY CONTROL DEVICE AND FREQUENCY CONTROL METHOD

(71) Applicant: FUJITSU LIMITED, Kawasaki-shi (JP)

(72) Inventor: Takahiro KAITO, Sendai (JP)

(73) Assignee: FUJITSU LIMITED, Kawasaki-shi (JP)

(21) Appl. No.: 14/089,365

(22) Filed: Nov. 25, 2013

(30) Foreign Application Priority Data
Mar. 18, 2013 (JP) 2013-055650

(51) Int. Cl. G06F 1/32

(52) U.S. Cl. CPC G06F 1/324
USPC 713/322

(57) ABSTRACT

For every application, a storage unit stores performance information which indicates processing performance required for processing of the application. A derivation unit derives processing performance required for processing of an application executed in a processor on the basis of the performance information. A frequency control unit controls an operation frequency of a CPU in accordance with the processing performance derived by the derivation unit.

### CROSS-REFERENCE TO RELATED APPLICATIONS

This application is based upon and claims the benefit of priority of the prior Japanese Patent Application No. 2013-055650, filed on Mar. 18, 2013, the entire contents of which are incorporated herein by reference.

### FIELD

The embodiments discussed herein is related to a frequency control device and a frequency control method.

### BACKGROUND

There are some processors in which the operation frequency (operation clock) can be dynamically changed. Some devices including such a processor exercise feedback control in which an immediately preceding use rate of the processor is detected and an operation frequency of the processor at the next timing is determined, and thereby suppresses power consumption.
Patent Literature 1: Japanese Laid-open Patent Publication No. 2007-133723

In the feedback control, however, the operation frequency of the processor at the next timing is determined on the basis of the immediately preceding use rate of the processor. Therefore, an optimum frequency is not necessarily selected and it is difficult to lower the power consumption in some cases.

### SUMMARY

According to an aspect of an embodiment, a frequency control device includes: a storage unit that stores, for every application, performance information which indicates processing performance required for processing of the application; a derivation unit that derives processing performance required for processing of an application executed in a processor on the basis of the performance information; and a frequency control unit that controls an operation frequency of the processor in accordance with the processing performance derived by the derivation unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a general configuration of a terminal device;

FIG. 2 is a diagram illustrating an example of a data configuration of a setting file;

FIG. 3 is a flow chart illustrating a procedure of control processing;

FIG. 4 is a flow chart illustrating a procedure of registration processing;

FIG. 5 is a diagram illustrating an example of a change of processing performance with time; and

FIG. 6 is a diagram illustrating a computer that executes a frequency control program.

### DESCRIPTION OF EMBODIMENTS

Preferred embodiments of the present invention will be explained with reference to accompanying drawings.

By the way, the present invention is not restricted by the embodiments. The embodiments can be combined suitably as long as processing contents are not contradictory to each other.

### [a] First Embodiment

A first embodiment will now be described. In the present embodiment, a case where an operation frequency of a processor such as a CPU (Central Processing Unit) or a MPU (Micro Processing Unit) incorporated in a terminal device is controlled will be described. FIG. 1 is a diagram illustrating a general configuration of a terminal device. A terminal device 10 is a device incorporating a processor that can be changed dynamically in operation frequency. The terminal device 10 is a portable terminal device such as, for example, a smart phone, a PDA (Personal Digital Assistant), or a portable telephone. By the way, the terminal device 10 may be an information processing device such as a desk top PC, a tablet PC, or a notebook PC. The present embodiment will be described by taking a case where the terminal device 10 is a smart phone as an example.

As illustrated in FIG. 1, the terminal device 10 includes a communication I/F (interface) unit 20, a display unit 21, an input unit 22, a storage unit 23, and a memory 24. Furthermore, the terminal device 10 includes a clock controller 25, a power supply control IC (Integrated Circuit) 26, a battery 27, a temperature sensor 28, and a CPU 29.

The communication I/F unit 20 is an interface that exercises communication control between the terminal device and another device. The communication I/F unit 20 transmits and receives various kinds of information via a network that is not illustrated. As such a network, an arbitrary communication network such as a LAN (Local Area Network), a VPN (Virtual Private Network), or a mobile communication network can be mentioned without distinction of wire or wireless. For example, the communication I/F unit 20 receives an earthquake early warning via a mobile communication network as a notice concerning a disaster. As one aspect of such a communication I/F unit 20, a network interface card such as a LAN card or a mobile communication module can be mentioned.

The display unit 21 is a display device that displays various kinds of information. For example, as the display unit 21, a display device such as an LCD (Liquid Crystal Display) or a CRT (Cathode Ray Tube) can be mentioned. The display unit 21 displays various kinds of information. For example, the display unit 21 displays various kinds of screens such as a screen of an application which will be described later.

The input unit 22 is an input device that inputs various kinds of information. For example, as the input unit 22, input devices such as various buttons provided on the terminal device 10 or a transmission type touch sensor provided on the display unit 21 can be mentioned. By the way, in the example in FIG. 1, a functional configuration is illustrated and consequently the display unit 21 and the input unit 22 are separated from each other. For example, however, a device having the display unit 21 and the input unit 22 configured as one body such as a touch panel may be used. Furthermore, the input unit 22 may be a keyboard, a mouse, or the like. The input unit 22 accepts an operation input from a user, and outputs operation information that indicates contents of the accepted operation to the CPU 29.

The storage unit 23 is a non-volatile storage device such as a flash memory, a hard disk, an SSD (Solid State Device), or an optical disk. The storage unit 23 stores an OS (Operating System) and various programs executed by the CPU 29. For example, the storage unit 23 stores various application programs 30. The application programs 30 includes application programs pre-installed by a manufacturer of the terminal device 10 and application programs installed by a user of the terminal device 10 via a network or the like later. Furthermore, the storage unit 23 stores various data. For example, the storage unit 23 stores performance information 31.

The performance information 31 is data obtained by storing information concerning processing performance required for processing of an application for every application. FIG. 2 is a diagram illustrating an example of a data configuration of the performance information. As illustrated in FIG. 2, the performance information 31 has items of “object application” and “required processing performance.” The item of the object application is an area used to store information concerning an object application for which the processing performance is stored. In the present embodiment, required processing performance is stored for every thread generated in the CPU 29 when executing an application, as information concerning processing performance required for processing of the application. In the thread, an application name including processing of the thread and identification information that identifies the thread, such as a thread name, are included. In the item of the object application, an application name including processing of a thread, and identification information of the thread are stored. By the way, in the example in FIG. 2, thread names of thread A to thread D are described in order to facilitate identification of respective threads. The item of the required processing performance is an area used to store information concerning processing performance required for processing of the thread. In the present embodiment, the number of times of processing per second required to execute the processing of the thread is stored as required processing performance. In the item of the required processing performance, the number of times of processing per second required to execute the processing of the thread is stored by using a value of MIPS (Million Instructions Per Second). As for the application program 30 pre-installed in the manufacturer of the terminal device 10, the manufacturer may register required processing performance of every thread. As for the application program 30 installed later, a registration unit 64, which will be described later, registers required processing performance.

In the example in FIG. 2, it is indicated that required processing performance is 1500 [MIPS] for the thread A. It is indicated that required processing performance is 2000 [MIPS] for the thread B. It is indicated that required processing performance is 500 [MIPS] for the thread C. It is indicated that required processing performance is 1000 [MIPS] for the thread D.

Referring back to FIG. 1, the memory 24 is a device that stores various data temporarily. For example, as the memory 24, a semiconductor memory such as a RAM (Random Access Memory) in which data can be rewritten can be mentioned. The memory 24 is utilized as a work area where various data are stored. Various programs executed in the CPU 29 and various data used in processing of the programs are stored in the memory 24. For example, when the terminal device 10 is started, the performance information 31 is read out from the storage unit 23 and stored in the memory 24 as performance information 32.

The clock controller 25 conducts setting of an operation frequency of the CPU 29. The clock controller 25 changes the operation frequency of the CPU 29 under control from a frequency control unit 63 which will be described later.

The power supply control IC 26 controls a voltage supplied from the battery 27 to the CPU 29, and changes the voltage supplied to the CPU 29 under control from the frequency control unit 63 which will be described later. Furthermore, the power supply control IC 26 detects a residual quantity of the battery 27 from a terminal voltage of the battery 27, and notifies the CPU 29 of the residual quantity of the battery 27. By the way, a different device may detect the residual quantity of the battery 27 and notify the CPU 29 of the residual quantity.

The battery 27 is connected to respective devices in the terminal device 10 including the CPU 29 via power interconnections which are not illustrated, to supply power.

The temperature sensor 28 is disposed in the terminal device 10 to detect a temperature in the terminal device 10. For example, the temperature sensor 28 is disposed in a portion where the temperature tends to become high such as the periphery of the CPU 29. The temperature sensor 28 notifies the CPU 29 of the detected temperature.

The CPU 29 is a device that controls the terminal device 10. The CPU 29 is adapted to be able to dynamically change the operation frequency under control from the clock controller 25. By the way, in the present embodiment, the terminal device 10 is supposed to have a single processor configuration with one CPU 29. However, the terminal device 10 may have a multi-processor configuration with a plurality of CPUs 29. In a case where the terminal device 10 includes a plurality of CPUs 29, the terminal device 10 is supposed to have a multi-processor configuration in which operation frequencies of respective CPUs 29 can be changed asynchronously.

The CPU 29 executes processing of programs that stipulate various processing procedures. For example, the CPU 29 includes a scheduler 40, a kernel 41, and a CPU monitor 42 owing to an OS which is read to operate. Furthermore, the CPU 29 is assigned a memory area by the kernel 41 and the CPU 29 executes processing of various application programs 30. As a result, an application process 43 operates. In the example illustrated in FIG. 1, two application processes 43A and 43B operate. The kernel 41 corresponds to multiple threads. It is supposed that one process can execute processing of a plurality of threads in parallel. In the example illustrated in FIG. 1, a thread A and a thread B are executed in the application process 43A. A thread C and a thread D are executed in the application process 43B.

The scheduler 40 conducts scheduling in order to execute processing of respective processes efficiently. For example, the scheduler 40 determines the priority order of each application process 43 in accordance with a weight value such as a priority of processing, determines an order of processing assignment, and assigns processing of each thread in the application process 43 to the CPU 29 in accordance with the determined order.

The kernel 41 is a portion that becomes a kernel of the OS. The kernel 41 provides a basic function for operating the terminal device 10. For example, the kernel 41 provides basic functions of the OS such as monitoring of respective application processes 43 and peripheral devices, management of resources such as the storage unit 23 and the memory 24, interrupt processing, and inter-process communication.

The CPU monitor 42 monitors various kinds of processing conducted by the CPU 29, and provides information concerning processing situations. For example, the CPU monitor 42 provides a use rate of the CPU 29 for every thread as the information concerning processing situations.

Furthermore, the CPU 29 functions as various processing units owing to operation of various programs. For example, the CPU 29 includes a derivation unit 60, a feedback control unit 61, a correction unit 62, a frequency control unit 63, and a registration unit 64.

The derivation unit 60 derives processing performance required for processing executed in the CPU 29. For example, the derivation unit 60 refers to the performance information 32 with respect to each thread in each application process 43 executed in the CPU 29, and derives processing performance required for processing of each thread. For example, in a case where the threads A to D are executed in the CPU 29, the derivation unit 60 derives 1500 [MIPS] as required processing performance for the thread A. Furthermore, the derivation unit 60 derives 2000 [MIPS] as required processing performance for the thread B. Furthermore, the derivation unit 60 derives 500 [MIPS] as required processing performance for the thread C. Furthermore, the derivation unit 60 derives 1000 [MIPS] as required processing performance for the thread D.

In a case where processing performance required for processing of each thread in each application process 43 is obtained, the derivation unit 60 adds up processing performance required for processing of the threads and derives processing performance required as a whole. For example, in a case where the threads A to D are executed in the CPU 29, the derivation unit 60 derives 1500+2000+500+1000=5000 [MIPS] as the processing performance required as a whole.

The derivation unit 60 derives an operation frequency of the CPU 29 that makes it possible to obtain the processing performance and suppress power consumption to the utmost, from the processing performance required as a whole. For example, it is supposed that the CPU 29 can change the operation frequency step by step and the power consumption is decreased as the operation frequency becomes lower. In this case, the derivation unit 60 specifies a lowest operation frequency that provides the processing performance required as a whole, as the operation frequency of the CPU 29. For example, supposing that the CPU 29 can change the operation frequency to 2 GHz, 2.5 GHz, and 3 GHz step by step and processing performance per GHz is 2100 [MIPS], the processing performance at 2.5 GHz is 5250 [MIPS] and the processing performance at 3 GHz is 6300 [MIPS]. Supposing that the required processing performance is 5000 [MIPS], the derivation unit 60 specifies 2.5 GHz as the operation frequency of the CPU 29 in this case. On the other hand, for example, it is supposed that the CPU 29 can change the operation frequency and the power consumption is low in a case where the CPU 29 operates at a predetermined use rate (for example, 70%). In this case, the derivation unit 60 specifies an operation frequency at which the CPU 29 provides the processing performance required as a whole at the predetermined use rate, as the operation frequency of the CPU 29. For example, supposing that the required processing performance is 5000 [MIPS], the derivation unit 60 specifies 5000/(0.7×2100)=3.4 GHz as the operation frequency of the CPU 29. By the way, it is also possible to store information of an operation frequency of the CPU 29 that yields lowest power consumption for every required processing performance and cause the derivation unit 60 to specify the operation frequency of the CPU 29 on the basis of the information. For example, required processing performance is obtained for every range obtained by dividing required processing performance into a plurality of ranges, and information indicating an operation frequency of the CPU 29 that makes power consumption the lowest is stored in the storage unit 23. The derivation unit 60 may specify an operation frequency in a range that includes the processing performance required as a whole, as the operation frequency of the CPU 29 on the basis of the information stored in the storage unit 23.

The feedback control unit 61 specifies the operation frequency of the CPU 29 at the next timing on the basis of the use rate of the CPU 29 detected by the CPU monitor 42. For example, in a case where required processing performance of a thread in the application processes 43 executed in the CPU 29 is not yet registered in the performance information 32, it is difficult for the derivation unit 60 to derive the processing performance required as a whole. In this case, the feedback control unit 61 specifies the operation frequency of the CPU 29 at the next timing on the basis of the use rate of the CPU 29 detected by the CPU monitor 42. For example, in a case where the use rate of the CPU 29 detected by the CPU monitor 42 is at least a predetermined value, the feedback control unit 61 changes the operation frequency to an operation frequency higher than the present operation frequency. The predetermined value is set equal to, for example, 90%. This predetermined value may be made adjustable from the external.

The correction unit 62 conducts various corrections. For example, in a case where an operation for an application is accepted from the input unit 22, the correction unit 62 corrects a priority of processing for the application of the accepted operation to make it higher. As a result, the scheduler 40 assigns processing in the CPU 29 preferentially to an application process 43 of the application changed to become higher in priority. Accordingly, processing on the application of the accepted operation can be executed preferentially.

Furthermore, for example, the correction unit 62 corrects an operation frequency of a target specified by the derivation unit 60 or the feedback control unit 61. If the temperature exceeds a predetermined range in which the operation is ensured, a trouble such as a false operation occurs in the terminal device 10 in some cases. In a case where the temperature within the device detected by the temperature sensor 28 becomes at least a predetermined allowable temperature, therefore, the correction unit 62 corrects the operation frequency of the target to a lower value in order to suppress generation of heat from the CPU 29. This predetermined allowable temperature is determined in accordance with specifications of devices in the terminal device 10. As a result, heat generation from the CPU 29 can be suppressed.

Furthermore, in a case where the residual quantity in the battery 27 is small, it is desirable for the terminal device 10 to suppress power consumption in the CPU 29 and suppress the decrease of the residual quantity in the battery 27 in order to keep the terminal device 10 in a usable state for a longer time period. In a case where the residual quantity in the battery 27 becomes a predetermined quantity or less, therefore, the correction unit 62 corrects the operation frequency of the CPU 29 to a lower value. The predetermined quantity is set equal to, for example, 20%. The predetermined quantity may be made adjustable from the external. As a result, decrease of the residual quantity in the battery 27 can be suppressed.

Furthermore, in a case where the display unit 21 is in an off state, it is not necessary to display a screen of an application on the display unit 21 and user's interest in processing executed in the terminal device 10 is low. Therefore, it is desirable to suppress the consumption of the battery 27. In the case where the display unit 21 is in the off state, therefore, the correction unit 62 corrects the operation frequency of the CPU 29 to a lower value. As a result, consumption of the battery 27 can be suppressed.

Furthermore, even in a case where the display unit 21 is in an on state, there is a case where the terminal device 10 is executing processing in a background without causing the display unit 21 to display a screen of the application. In general, processing executed in the background is low in priority and the processing speed is not regarded as important. In a case where processing of each application is executed in the background, the correction unit 62 corrects the operation frequency of the CPU 29 to a lower value. As a result, consumption of the battery 27 can be suppressed.

Furthermore, in a case where a disaster or the like has occurred, it is difficult for the terminal device to charge the battery 27 because of occurrence of a power failure in some cases. In a case where a notice concerning a disaster is received, therefore, the correction unit 62 corrects the operation frequency of the CPU 29 to a lower value. For example, in a case where an earthquake early warning is received, the correction unit 62 corrects the operation frequency of the CPU 29 to a lower value. As a result, consumption of the battery 27 can be suppressed. By the way, in a case where an earthquake early warning is received, for example, the storage unit 23 is caused to store information to the effect that an earthquake early warning is received, the display unit 21 is caused to display to the effect that setting of correcting the operation frequency to a lower value is conducted, and the correction unit 62 conducts correction continuously until a predetermined cancel operation is conducted.

In the case where the temperature within the device has become at least the predetermined allowable temperature, the case where the residual quantity in the battery 27 has become the predetermined quantity or less, the case where the display unit 21 is in the off state, and the case where an earthquake early warning is received, the correction unit 62 may lower the operation frequency of the CPU 29 to different values, respectively. Furthermore, the correction unit 62 may lower the operation frequency to the same value in some or all of the cases. For example, the storage unit 23 is caused to store a rate of the operation frequency to be lowered or a value to which the operation frequency is to be lowered in each case as correction information, and the correction unit 62 lowers the operation frequency on the basis of the correction information when each case has occurred. Furthermore, in a case where the state comes under a plurality of cases, the correction unit 62 corrects the operation frequency of the target to the lowest operation frequency value. Furthermore, while the operation frequency of the CPU 29 is at least a predetermined value, the correction unit 62 may correct the operation frequency of the CPU 29 to a lower value. For example, in a case where the operation frequency of the CPU 29 can be changed to 2 GHz, 2.5 GHz, and 3 GHz step by step and the CPU 29 is operating at 3 GHz resulting in larger power consumption, the correction unit 62 corrects the operation frequency to a lower value. As a result, it can be implemented that correction is conducted only in a case where the power consumption of the CPU 29 is large.

Although the correction unit 62 corrects the operation frequency of the CPU 29 to a lower value here, the correction unit 62 does not stop the operation of the CPU 29. Processing of each application process 43 executed in the CPU 29 is continued although time required for processing becomes long.

The frequency control unit 63 controls the operation frequency of the CPU 29. For example, the frequency control unit 63 controls the power supply control IC 26 and the clock controller 25 to cause the operation frequency of the CPU 29 to become an operation frequency of the target derived by the derivation unit 60 and corrected by the correction unit 62. For example, the frequency control unit 63 orders the power supply control IC 26 to change the voltage to a drive voltage of the target at the operation frequency. As a result, in a case where the operation frequency of the target is lower than the current operation frequency of the CPU 29, the power supply control IC 26 lowers the drive voltage. In a case where the operation frequency of the target is higher than the current operation frequency of the CPU 29, the power supply control IC 26 raises the drive voltage. The frequency control unit 63 orders the clock controller 25 to change the operation frequency to the operation frequency of the target. As a result, the clock controller 25 changes the operation frequency of the CPU 29 to the ordered operation frequency.

The registration unit 64 registers processing performance required for processing of an application into the performance information 32. For example, in a case where there is a thread in an application process 43 for which required processing performance is not yet registered in the performance information 32, the registration unit 64 finds processing performance required for processing of the thread. In a steady state in which a time period having no operation on the input unit 22 continues and the number of conversions in processing of each thread is small, the registration unit 64 detects the use rate of the CPU 29 in each thread by using the CPU monitor 42. The registration unit 64 then calculates processing performance required for processing of the thread on the basis of the use rate of the CPU 29 in the thread and the operation frequency of the CPU 29. For example, it is supposed that the use rate of the CPU 29 in the thread detected by the CPU monitor 42 is 50%, the operation frequency of the CPU 29 is 1 GHz, and processing performance per GHz is 2100 [MIPS]. In this case, the registration unit 64 calculates 1×0.5×2100=1050 as processing performance required for processing of the thread. The registration unit 64 then registers the calculated processing performance required for processing of the thread into the performance information 32 as processing performance required for processing of the thread. As a result, required processing performance of the thread in the application process 43 for which required processing performance has not yet been registered is registered into the performance information 32. As regards an application program 30 installed later as well, therefore, required processing performance can be learned. By the way, with respect to an unregistered thread in an application process 43, the registration unit 64 may calculate required processing performance a plurality of times and register an average value. Furthermore, as for an application program 30 preinstalled in the manufacturer as well, in a case where required processing performance is not yet registered, the registration unit 64 may register required processing performance into the performance information 32. Furthermore, as for a thread for which required processing performance is already registered in the performance information 32 as well, the registration unit 64 may calculate required processing performance and update the performance information 32 to an average value of the calculated required processing performance and the registered required processing performance.

The registration unit 64 overwrites and stores the performance information 32 stored in the memory 24 into the storage unit 23 as the performance information 31 at predetermined timing. For example, the registration unit 64 overwrites and stores the performance information 32 as the performance information 31 at timing of power supply turning off of the terminal device 10 or timing of every determinate repetition period. As a result, the registration unit 64 can reflect the processing performance registered in the performance information 32 to the performance information 31.

A flow of control processing in which the terminal device 10 according to the present embodiment controls the operation frequency of the CPU 29 will now be described. FIG. 3 is a flow chart illustrating a procedure of the control processing. This control processing is executed at timing of a change of the executed application program 30 such as, for example, at timing of start of the application program 30 and timing of end of the started application program 30. By the way, the control processing may be executed periodically.

As illustrated in FIG. 3, the derivation unit 60 refers to the performance information 32 and determines whether processing performance required for processing of each thread in each application process 43 executed in the CPU 29 is previously stored in the performance information 32 (S10). In a case where the processing performance is previously stored in the performance information 32 (S10 is affirmative), the derivation unit 60 reads out processing performance required for processing of each thread from the performance information 32 and derives processing performance required for processing of each thread (S11). The derivation unit 60 then adds up processing performance required for processing of threads, derives processing performance required as a whole, and calculates an operation frequency of the CPU 29 at which power consumption can be most suppressed from the processing performance required as a whole (S12).

On the other hand, unless processing performance of some or all of threads is previously stored (S10 is negative), the derivation unit 60 starts registration processing which will be described later (S13). As for this registration processing, processing is executed in parallel with the control processing. The feedback control unit 61 then specifies the operation frequency of the CPU 29 at the next timing on the basis of the use rate of the CPU 29 detected by the CPU monitor 42 (S14).

The correction unit 62 determines whether an operation on an application is accepted from the input unit 22 (S15). In a case where an operation is not accepted (S15 is negative), the processing proceeds to S17 which will be described later. On the other hand, in a case where an operation is accepted (S15 is affirmative), the correction unit 62 corrects priority of processing of an application for which the operation is accepted to a higher priority (S16).

The correction unit 62 determines whether the temperature within the device detected by the temperature sensor 28 is at least a predetermined allowable temperature (S17). In a case where the temperature within the device is at least the predetermined allowable temperature (S17 is affirmative), the processing proceeds to S22 which will be described later.

On the other hand, in a case where the temperature within the device is not at least the predetermined allowable temperature (S17 is negative), the correction unit 62 determines whether the residual quantity in the battery 27 is a predetermined quantity or less (S18). In a case where the residual quantity in the battery 27 is the predetermined quantity or less (S18 is affirmative), the processing proceeds to S22 which will be described later.

On the other hand, in a case where the residual quantity in the battery 27 is not the predetermined quantity or less (S18 is negative), the correction unit 62 determines whether the display unit 21 is in an off state (S19). In a case where the display unit 21 is in the off state (S19 is affirmative), the processing proceeds to S22 which will be described later.

On the other hand, in a case where the display unit 21 is not in the off state (S19 is negative), the correction unit determines whether processing of each application is being executed in the background (S20). In a case where the processing of each application is being executed in the background (S20 is affirmative), the processing proceeds to S22 which will be described later.

On the other hand, in a case where processing of some or all of applications is not being executed in the background (S20 is negative), the correction unit 62 determines whether a notice concerning a disaster is received (S21). In a case where a notice concerning a disaster is received (S21 is affirmative), the processing proceeds to S22 which will be described later. On the other hand, in a case where a notice concerning a disaster is not received (S21 is negative), the processing proceeds to S23 which will be described later.

According to each of the cases, the correction unit 62 corrects the operation frequency of the target found at the S12 or S14 (S22). The frequency control unit 63 controls the power supply control IC 26 and the clock controller 25 to cause the operation frequency of the CPU 29 to become the operation frequency of the target (S23), and finishes the processing.

A flow of registration processing in which the terminal device 10 according to the present embodiment registers processing performance of a thread in an application process 43 for which required processing performance is not yet registered will now be described. FIG. 4 is a flow chart illustrating a procedure of the registration processing. This registration processing is executed, for example, at timing of being started at S13 in the above-described control processing.

As illustrated in FIG. 4, the registration unit 64 detects a use rate of the CPU 29 in each of unregistered threads by using the CPU monitor 42, in a steady state in which any operation is not conducted on the input unit 22 (S30). The registration unit 64 then calculates processing performance required for processing of each unregistered thread on the basis of the use rate of the CPU 29 in each unregistered thread and the operation frequency of the CPU 29 (S31). The registration unit 64 registers the calculated processing performance required for processing of the thread into the performance information 32 stored in the memory 24 as processing performance required for processing of the thread (S32), and finishes the processing.

For every application, the terminal device 10 stores performance information that indicates processing performance required for processing of the application into the storage unit 23 in this way. The terminal device 10 derives processing performance required for processing of an application executed in the CPU 29, on the basis of the performance information. The terminal device 10 then controls the operation frequency of the CPU 29 in accordance with the derived processing performance. As a result, the terminal device 10 can cause the CPU 29 to operate with processing performance required for processing of the application. Accordingly, the power consumption can be suppressed.

Furthermore, the terminal device 10 calculates processing performance required for processing of an application on the basis of a use rate of the CPU 29 for the application at the time when the application is being executed in the CPU 29 and processing performance of the CPU 29, and registers the calculated processing performance into the performance information. Even in a case where an application is added later, therefore, the terminal device 10 can register processing performance required for processing of the added application into the performance information.

Furthermore, in a case where an operation on an application is accepted, the terminal device 10 corrects priority of processing of the application for which the operation is accepted to a higher priority. As a result, the terminal device 10 can cause processing of the application for which the operation is accepted to be executed preferentially. Accordingly, lowering in operability of the application can be suppressed.

Furthermore, in a case where the temperature within the device has become at least a predetermined allowable temperature, the terminal device 10 corrects the operation frequency of the CPU 29 to a lower value. As a result, the terminal device 10 can suppress heat generation from the CPU 29. Accordingly, the temperature rise within the device can be suppressed.

Furthermore, in a case where the residual quantity in the battery 27 is a predetermined quantity or less, the terminal device 10 corrects the operation frequency of the CPU 29 to a lower value. As a result, the terminal device 10 can suppress power consumption and suppress decrease of the residual quantity in the battery 27.

Furthermore, in a case where the display unit 21 is in the off state, the terminal device 10 corrects the operation frequency of the CPU 29 to a lower value. As a result, the terminal device 10 can suppress power consumption and suppress decrease of the residual quantity in the battery 27.

Furthermore, in a case where processing of an application is executed in the background, the terminal device 10 corrects the operation frequency of the CPU 29 to a lower value. As a result, the terminal device 10 can suppress power consumption and suppress decrease of the residual quantity in the battery 27.

Furthermore, in a case where a notice concerning a disaster is received, the terminal device 10 corrects the operation frequency of the CPU 29 to a lower value. As a result, the terminal device 10 can suppress power consumption and suppress decrease of the residual quantity in the battery 27.

Furthermore, while the operation frequency of the CPU 29 is at least a predetermined value, the terminal device 10 corrects the operation frequency of the CPU 29 to a lower value. As a result, the terminal device 10 can prevent the CPU 29 from operating at a high operation frequency resulting in large power consumption.

Furthermore, the terminal device 10 stores the required processing performance as the number of times of processing per second. Even in a case where a different processor such as a CPU or a MPU is used, therefore, the terminal device 10 can utilize the performance information 31 as it is and can calculate a required operation frequency simply.

### [b] Second Embodiment

Heretofore, an embodiment concerning the disclosed device has been described. However, the disclosed technique may be executed in various different forms besides the above-described embodiment. Hereafter, therefore, other embodiments incorporated in the present invention will be described.

For example, in the above-described embodiment, the case where processing performance required for processing of an application is stored as required processing performance for every thread has been described. However, the disclosed device is not restricted to this. For example, it is also possible to add up processing performance of threads for every application and store resultant processing performance as processing performance required for processing of the application.

Furthermore, in the above-described embodiment, the case where required processing performance is stored as the number of times of processing per second has been described. However, the disclosed device is not restricted to this. For example, the processing performance required for processing of the application may be stored as the operation frequency. Furthermore, the processing performance required for processing of the application may be stored as a weight value, a use rate of the CPU 29, or the like.

Furthermore, in the above-described embodiment, the case where when an operation on an application is accepted the correction unit 62 corrects the priority of processing of the application for which the operation is accepted to a higher priority has been described. However, the disclosed device is not restricted to this. For example, the correction unit 62 may raise the processing performance required for processing of the application for which the operation is accepted, for a predetermined time and return the required processing performance to the processing performance changing with time, after elapse of a predetermined time.

Furthermore, in the above-described embodiment, the case where processing performance required for processing of an application in the steady state is stored in the performance information 31 has been described. However, the disclosed device is not restricted to this. For example, it is also possible to store processing performance changing with time required for processing of an application into the performance information 31 and change the operation frequency of the CPU 29 in accordance with a change of processing performance required for processing of the application with time on the basis of the performance information 31. For example, the use rate of the CPU 29 in the processing of the application is sampled periodically at constant time intervals. It is also possible to find processing performance required for processing of the application that changes with time on the basis of the operation frequency and the sampled use rate of the CPU 29, find the moving average for every predetermined number, and regard the moving average as processing performance changing with time. FIG. 5 is a diagram illustrating an example of a change of processing performance with time. In an example in FIG. 5, the required processing performance is illustrated as the operation frequency. For example, the use rate of the CPU 29 in the processing of the application is sampled periodically at intervals in the range of approximately 10 to 300 ms. In the example in FIG. 5, the operation frequency of the CPU 29 required for processing of the application is found as an actual operation frequency by multiplying the operation frequency of the CPU 29 by the use rate. A moving average of actual operation frequencies including two immediately preceding actual operation frequencies is found. The number of actual operation frequencies used to find the moving average may be adjusted in accordance with characteristics of a change of processing performance required for processing of the application.

Furthermore, for example, processing performance required for processing of the application that changes with time over a predetermined period lasting since start of the application until stabilization in the steady state, and processing performance required for processing in the steady state may be stored in the performance information 31. In this case, the terminal device 10 may control the operation frequency of the CPU 29 by using the processing performance changing with time over the predetermined period since start of the application and control the operation frequency of the CPU 29 by using the processing performance required for processing in the steady state after elapse of the predetermined period.

Furthermore, for example, it is also possible to store required processing performance in a plurality of states into the performance information 31 for every application, and switch required processing performance in accordance with the state of the application. For example, required processing performance in the steady state and required processing performance in a state in which an operation is accepted are stored in the performance information 31. In the case of the steady state, the terminal device 10 may control the operation frequency of the CPU 29 by using the required processing performance in the steady state. In a case where an operation is accepted, the terminal device 10 may control the operation frequency of the CPU 29 by using the required processing performance in the state in which an operation is accepted.

Furthermore, illustrated components in devices are function conceptual, and they need not be configured physically as illustrated. In other words, concrete states of breakup and unification of devices are not restricted to the illustrated states. In the configuration, some or all of them can be broken up and unified functionally or physically with an arbitrary unit according to various loads and use situations. For example, various processing units such as the derivation unit 60, the feedback control unit 61, the correction unit 62, the frequency control unit 63, and the registration unit 64 illustrated in FIG. 1 may be unified or broken up as the occasion may demand. Furthermore, as for respective processing functions conducted in respective processing units, arbitrary some or all of them can be implemented by a CPU or a program analyzed and executed in the CPU, or can be implemented as hardware using a wired logic.

(Frequency Control Program)

Furthermore, various kinds of processing described in the embodiments can also be implemented by executing a previously prepared program in a personal computer or a computer system such as a work station. Hereafter, therefore, an example of a computer system that executes a program having the same function as the embodiments will be described. FIG. 6 is a diagram illustrating a computer that executes a frequency control program.

As illustrated in FIG. 6, a computer 300 includes a CPU 310, a ROM (Read Only Memory) 320, a HDD (Hard Disk Drive) 330, and a RAM (Random Access Memory) 340. These units 310 to 340 are connected via a bus 400.

A frequency control program 320a which exhibits the same functions as those of the processing units in the above-described embodiments is previously stored in the ROM 320. For example, the frequency control program 320a that exhibits the same functions as those of the derivation unit 60, the feedback control unit 61, the correction unit 62, the frequency control unit 63, and the registration unit 64 in the above-described embodiments is stored. By the way, the frequency control program 320a may be separated as the occasion may demand.

Various data are stored in the HDD 330. For example, the HDD 330 stores an OS and various data.

The CPU 310 reads out the frequency control program 320a from the ROM 320, and executes the frequency control program 320a. As a result, the same operations as those of the respective processing units in the embodiments are executed. In other words, the frequency control program 320a executes the same operations as those of the derivation unit 60, the feedback control unit 61, the correction unit 62, the frequency control unit 63, and the registration unit 64 in the embodiments.

By the way, it is not always necessary to store the frequency control program 320a in the ROM 320 from the beginning. The frequency control program 320a may be stored in the HDD 330.

For example, the program is previously stored on a “portable physical medium” such as a flexible disk (FD), a Compact Disk Read Only Memory (CD-ROM), a Digital Versatile Disk (DVD), an optical magnetic disk, or an IC card inserted into the computer 300. The computer 300 may read out the program from them and execute the program.

Furthermore, the program is previously stored in “another computer (or server)” or the like connected to the computer 300 via a public line, Internet, a LAN, a WAN, or the like. The computer 300 may read out the program from them and execute the program.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A frequency control device comprising:
a storage unit that stores, for every application, performance information which indicates processing performance required for processing of the application;
a derivation unit that derives processing performance required for processing of an application executed in a processor on the basis of the performance information; and
a frequency control unit that controls an operation frequency of the processor in accordance with the processing performance derived by the derivation unit.

2. The frequency control device according to claim 1, further comprising a registration unit that calculates processing performance required for processing of an application based on a use rate of the processor for the application at time when executing the application in the processor and processing performance of the processor, and registers the calculated processing performance into the performance information.

3. The frequency control device according to claim 1, further comprising a correction unit that corrects priority of processing of an application for which an operation is accepted to higher priority, in a case where the operation for the application is accepted.

4. The frequency control device according to claim 3, wherein in a case where a temperature within the device has become at least a predetermined allowable temperature, the correction unit corrects the operation frequency of the processor to a lower value.

5. The frequency control device according to claim 3, wherein in a case where a residual quantity in a battery that supplies power to the processor is a predetermined quantity or less, the correction unit corrects the operation frequency of the processor to a lower value.

6. The frequency control device according to claim 3, wherein in a case where a display unit that displays a screen of an application executed in the processor is in an off state, the correction unit corrects the operation frequency of the processor to a lower value.

7. The frequency control device according to claim 3, wherein in a case where processing of an application is executed in a background, the correction unit corrects the operation frequency of the processor to a lower value.

8. The frequency control device according to claim 3, wherein in a case where a notice concerning a disaster is received, the correction unit corrects the operation frequency of the processor to a lower value.

9. The frequency control device according to claim 3, wherein while the operation frequency of the processor is at least a predetermined value, the correction unit corrects the operation frequency of the processor to a lower value.

10. A frequency control method comprising:
deriving, using a processor, processing performance required for processing of an application executed in a processor, on the basis of performance information that is stored in a storage unit and that indicates for every application, processing performance required for processing of the application; and
controlling, using the processor, an operation frequency of the processor in accordance with the derived processing performance.

11. A computer-readable recording medium having stored therein a frequency control program for causing a computer to execute a process, the process comprising:
deriving processing performance required for processing of an application executed in a processor, on the basis of performance information that is stored in a storage unit and that indicates for every application, processing performance required for processing of the application; and
controlling an operation frequency of the processor in accordance with the derived processing performance.
